(19) United States
(12) Patent Application Publication
(10) Pub. No.: US 2009/0152276 A1
(43) Pub. Date: Jun. 18, 2009

(54) Griddle Plate and Cookware Having a Vacuum Bonded, High Conductivity, Low Density Carbon Foam Core Plate

(75) Inventor: William A. Groll, McMurray, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ALL-CLAD METALCRAFTERS LLC, Canonsburg, PA (US)

(21) Appl. No.: 12/389,760

(22) Filed: Feb. 20, 2009

Related U.S. Application Data
(63) Continuation-in-part of application No. 11/439,507, filed on May 23, 2006.
Application No. 11/439,507 is a continuation-in-part of application No. 11/245,478, filed on Oct. 6, 2005.
(60) Provisional application No. 60/616,801, filed on Oct. 7, 2004.

(51) Int. Cl. A47J 27/00; H05B 3/22; A47J 27/12; A47J 36/00; A47J 36/24

(52) U.S. Cl. 220/573.4; 219/443.1; 219/452.11; 219/465.1; 220/592.27; 426/523

(57) ABSTRACT

A composite griddle plate or cookware comprising a first metal sheet defining a cook surface and a core plate of carbon foam having a relatively high coefficient of heat conductivity and a low density. A second metal sheet is peripherally sealed by welding or the like to the first metal sheet. The first and second sheets remain in intimate contact with the upper and lower surfaces of the core plate with the aid of a vacuum. In a further cooking appliance embodiment, a food vessel intimately engages the carbon foam plate beneath a food-contacting surface thereof while the carbon foam plate on its opposite side engages a heat sink plate by virtue of a vacuum. The vacuum eliminates air gaps between the food-contacting surface of the food vessel and the carbon foam plate and the heat sink plate so as to provide instantaneous and uniform heating of the food vessel. The vacuum environment also provides thermal insulation for the heat sink plate whereby heat loss by convection is virtually eliminated.

### CROSS-REFERENCE TO RELATED APPLICATIONS

This application is a continuation-in-part of co-pending U.S. application Ser. Nos. 11/245,478 filed Oct. 6, 2005, and 11/439,507 filed May 23, 2006, and claims the benefit of U.S. Provisional Application No. 60/616,801 filed Oct. 7, 2004, all of which are hereby incorporated by reference in their entirety.

### BACKGROUND OF THE INVENTION

1. Field of the Invention

The present invention relates generally to cooking griddles and cookware and, more particularly, to a composite cooking griddle or cookware having a thin cook surface layer, preferably of stainless steel or aluminum or a composite metal, that intimately contacts a thicker heat conductive core plate of carbon foam by means of a vacuum.

2. Description of Related Art

Briefly stated, the invention disclosed in my earlier co-pending parent application Ser. No. 11/245,478 is directed to a composite griddle plate comprising a core consisting of a metal plate having a high coefficient of thermal conductivity such as copper or aluminum. The core plate is faced at least with an upper sheet of a metal such as stainless steel or titanium which defines the cook surface of the griddle plate. The interface between the core plate and upper sheet is under the reduced pressure of a vacuum so as to cause intimate contact between the core and cook surface which increases the thermal conductivity to the cook surface and, thus, reduces the thermal recovery time of the griddle.

Various additional embodiments of the original invention are also disclosed in the earlier parent application. For example, the griddle plate of one such embodiment comprises a high heat conductivity core of copper or aluminum having upper and lower sheets of stainless steel in intimate contact with the core. The entire perimeter of the griddle plate is sealed as by welding and the interior is under a permanently sealed vacuum. Another such embodiment utilizes an upper sheet of stainless steel or other metal having a non-stick coating applied thereto. The upper sheet is removably secured to the heat conductive core plate under vacuum utilizing a high temperature gasket or adhesive sealant to maintain the vacuum. The upper sheet may be mechanically secured by bolts or the construction may be placed under a constant vacuum using a vacuum pump. When the non-stick surface ages and/or otherwise loses its non-stick properties, such as with a PTFE-type non-stick coating, the upper sheet can be easily replaced with a freshly non-stick coated upper sheet and the vacuum reestablished.

Briefly stated, one preferred embodiment of the invention disclosed in the second co-pending application Ser. No. 11/439,507 comprises a heat sink plate of aluminum with heating means associated therewith. The heat sink is surrounded by a vacuum when in use so as to provide a heat insulating environment for the heat sink so as to minimize heat loss and maximize energy efficiency. A food vessel tightly engages the heat sink along the cook surface thereof by virtue of the vacuum. In preferred embodiments, the invention contemplates that the heat sink is enclosed by a metal pot-shaped shell which communicates with a vacuum pump. The invention includes sealing means to contain the vacuum between the shell and the food vessel. The food vessel is removable from vacuum engagement with the shell and heat sink to permit easy cleaning thereof. When the food vessel is so removed, the heat sink may be preheated or maintained at temperature under vacuum through the use of a lid which engages the sealing means and maintains the vacuum within the shell and around the heat sink. When the food vessel is prepared and loaded with ingredients for cooking, the vacuum is halted to permit removal of the lid and insertion of the food vessel in the shell. The vacuum is again established around the heat sink for heat insulation of the heat sink and for tight engagement between the heat sink and the cook surface of the food vessel.

The present invention solves the problems heretofore encountered in the prior art by providing a composite griddle plate or cookware having a core plate of high conductivity foam material encapsulated in a vacuum which transfers heat to an outer cook surface layer of metal, much like a roll bonded composite, but at a much lower weight.

### SUMMARY OF THE INVENTION

Briefly stated, the present invention is directed to a composite griddle plate or cookware comprising a core consisting of a carbon foam material having a high coefficient of thermal conductivity and low density. The core plate is faced with upper and lower sheets of a metal such as stainless steel, titanium, aluminum, or a composite metal which defines the cook surface on one side. The spaces between the core plate and the upper and lower sheets is under the reduced pressure of a vacuum so as to cause intimate contact between the core plate and cook surface and lower heated surface and core plate, which increases the thermal conductivity to the cook surface.

Various additional presently preferred embodiments of the invention are disclosed herein. For example, the griddle plate of one such embodiment comprises a high heat conductivity core plate of carbon foam having upper and lower sheets of stainless steel in intimate contact with the core plate. The entire perimeter of the griddle plate is sealed as by welding and the interior is under a permanently sealed vacuum. Another such presently preferred embodiment utilizes an upper sheet of stainless steel or other metal having a non-stick coating applied thereto. The upper sheet is removably secured above the heat conductive core plate to a lower metal sheet under vacuum utilizing a high temperature gasket or adhesive sealant to maintain the vacuum. The upper sheet may be mechanically secured by bolts or the construction may be placed under a constant vacuum using a vacuum pump. When the non-stick surface ages and/or otherwise loses its non-stick properties, such as with a PTFE-type non-stick coating, the upper sheet can be easily replaced with a freshly non-stick coated upper sheet and the vacuum reestablished.

Another preferred embodiment suitable for cookware includes a core plate of carbon foam sealed under a permanent vacuum between two thin sheets of a metal selected from aluminum, stainless steel, or a roll-bonded composite containing aluminum and stainless steel. The upper sheet of metal is formed with a raised sidewall in the shape of a fry pan, stock pot or the like.

Briefly stated, another presently preferred embodiment of the present invention in the form of a cooking or food warming appliance comprises a heat sink plate with heating means associated therewith. A carbon foam plate is placed on the top surface of the heat sink plate. The heat sink and carbon foam plate are surrounded by a vacuum when in use so as to provide a heat insulating environment for the heat sink so as to minimize heat loss and maximize energy efficiency. A food vessel tightly engages the upper surface of the carbon foam plate along the cook surface thereof by virtue of the vacuum. In preferred embodiments, the invention contemplates that the heat sink is enclosed by a metal pot-shaped shell, the interior of which communicates with a vacuum pump. The invention includes sealing means to contain the vacuum between the shell and the food vessel.

These, as well as other attributes of my invention, will become more readily apparent when reference is made to the accompanying drawings taken with the detailed description.

### BRIEF DESCRIPTION OF THE DRAWINGS

FIG. 1 is a cross-sectional, exploded view of the construction of one presently preferred embodiment of a griddle plate of the present invention;

FIG. 2 is a cross-sectional side view of the griddle plate of the invention, similar to FIG. 1, taken along section line II-II of FIG. 3;

FIG. 3 is a plan view of the griddle plate with the top sheet removed as viewed along line III-III of FIG. 2;

FIG. 4 is a cross-sectional side elevation view of a further embodiment of the griddle plate of the invention;

FIG. 5 is a plan view of the griddle plate of FIG. 4;

FIGS. 6A and 6B depict a further presently preferred embodiment of the present invention in the form of cookware;

FIGS. 7A to 7C depict yet another presently preferred embodiment of my invention;

FIG. 8 is a cross-sectional view of the construction of one presently preferred embodiment of the vacuum cooking appliance of the present invention; and

FIG. 9 is a cross-sectional view of another embodiment of the vacuum cooking appliance of the present invention.

### DETAILED DESCRIPTION OF THE INVENTION

In my earlier-filed co-pending applications, the core plate which is sealed within the vacuum environment is of a high thermal conductivity material such as copper or aluminum. In the present invention, the core plate is also made from a high thermal conductive material but of much lower density than copper and even aluminum. As a result, the cookware, griddle plate, or cooking appliance incorporating this new core plate is much lighter than my previously disclosed embodiments using thick copper and aluminum core plates. The material for the new core plate of the invention is a carbon foam material commercially marketed by the Koppers Company under the registered trademark “KFOAM”® This material is described at www.kfoam.com (incorporated by reference herein) by the manufacturer as a highly oriented, low density, porous carbon structure produced from mesophase pitch. This pitch is heat treated at elevated temperatures to form a graphitic foam structure of highly aligned ligaments within the cell walls of the foam to provide very high thermal conductivity to the material. The thermal conductivity of the foam material currently ranges from 55 to 110 W/mK with a low coefficient of thermal expansion. The graphitic foam material is referred to herein merely as “carbon foam”, it being understood that the carbon is in the graphitc state so as to achieve the high thermal conductivity desired.

In the present invention, the resultant griddle plate or cookware utilizing a core plate of the carbon foam material is considerably lighter in weight than the previously disclosed embodiments using copper or aluminum core plates while exhibiting improved thermal conductivity properties. By way of example, the carbon foam material has a density range of 0.35 to 0.60 g/cc which is about 5% that of copper and about 20% the density of aluminum. This makes the present invention particularly attractive for cookware such as a fry pan which is manually carried and lifted by the user.

While the thermal conductivity and low density physical properties of the carbon foam material are excellent for cookware applications, the porous nature of this material (75-80% open porosity) is also problematic for food preparation usages. The porous nature of the carbon foam will readily attract and absorb moisture and bacteria when left in an exposed state in contact with liquid. In addition, the carbon foam material is not nearly as strong as commonly used metals for cookware such as aluminum, stainless steel, bonded composites, or copper and, accordingly, it cannot withstand the rigors of cookware use due to impact, abrasion, etc., even if its exposed surfaces are coated with a protective paint to prevent liquid absorption. Even in a case where the foam material is covered and sealed within a metal envelope, there would be a problem when the material is heated and the gas entrapped within the cells of the foam structure thermally expands and is released. Any such entrapped, expanding gas would cause a rupture of the metal enclosure.

In order to overcome these serious problems encountered with the use of carbon foam material in cookware involving unwanted water/liquid absorption, bacteria growth, and/or gas entrapment, I utilize my previously described sealed vacuum environment to prevent any of these problems from developing. I have also found that the carbon foam material appears to be excellent in conducting heat in all directions to provide uniform heating across a cooking surface. The carbon foam material also possesses a relatively low coefficient of thermal expansion, which makes it an ideal material as a core plate in the present invention so as to provide a very flat cook surface upon heating.

As in the previously described embodiments, when the carbon foam core plate is placed under a vacuum between upper and lower metal sheets, such as, for example, aluminum sheets, the vacuum forces the aluminum sheets to tightly engage the upper and lower planar surfaces of the carbon foam core plate so as to establish excellent thermal conductivity thereacross. In the course of drawing the vacuum, all of the gas present in the cells of the carbon foam is evacuated. After the upper and lower metal sheets are sealed together, as by welding, a vacuum tight environment remains in the interior to protect the carbon foam core plate from exposure to water, air, and/or bacteria. The carbon foam plate can also be heated prior to or during the vacuum sealing step to ensure that all gas and moisture are removed from the porous foam.

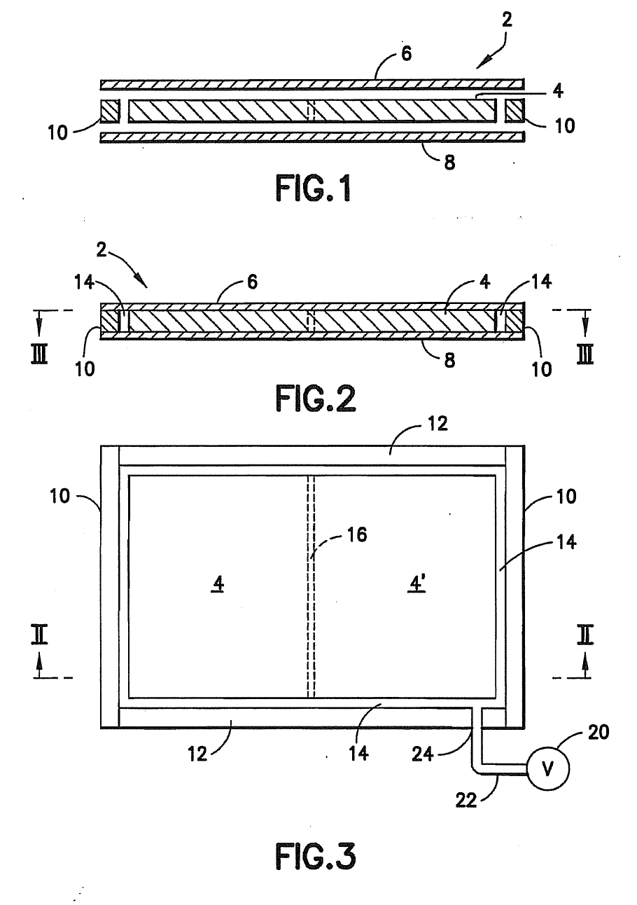

Reference will now be made to the drawings. One presently preferred embodiment of the present invention is depicted in FIGS. 1-3 showing a composite griddle plate 2 comprising a core plate 4 having an upper sheet or cook surface 6 and a lower sheet 8. The core plate 4 is a carbon foam having a high coefficient of thermal conductivity and low density as previously described. The sheets 6 and 8 in a preferred embodiment of the griddle plate are both selected from stainless steel such as Type 304 stainless. However, they need not be of the same type. For example, the upper sheet may be of 304 stainless while the bottom sheet 8 can be a ferromagnetic material such as a carbon steel or a 400 grade ferritic stainless steel for induction cooking purposes. Bottom sheet 8 could also be a nickel/iron material having a Curie temperature within a selected range for griddle cooking. One such material is, for example, 30-50 nickel/balance iron, which has a Curie temperature under induction cooking conditions of from about 400°-450° F. The upper sheet 6 can also be made from titanium which offers a very hard scratch-resistant cook surface which is relatively lightweight and is inert to food products.

I have also noted that the carbon foam material itself heats rapidly when exposed to an induction heating means, making it suitable for induction heating.

The composite griddle plate 2, as shown in the exploded view of FIG. 1, is formed as a welded pack having bars 10 along the ends and bars 12 along the sides forming a border around the perimeter of the griddle plate 2. The upper and lower sheets 6 and 8, respectively, are welded to the bars 10 and 12 to form an airtight seal around the perimeter of the griddle plate 2. Preferably, a small space 14 is maintained between the bars 10 and 12 and the peripheral edges of the core plate 4 to permit improved evacuation of the interior space 14 between the bars 10, 12 and the core plate 4. A vacuum pump 20 (FIG. 3) communicates with the interior space 14 by way of a conduit 22. The vacuum pump 20 withdraws the atmosphere from the interior of the griddle plate after the assembly has been welded. The pump 20 preferably pulls a vacuum while the composite griddle plate 2 is heated to about 400° F. to drive off the volatiles and expand the atmosphere within the interior. The vacuum is pumped down preferably to at least 25-30 inches of mercury. At that point the area of the conduit 22 indicated at 24 along the perimeter of the griddle shown in FIG. 3 is closed off and sealed to maintain the vacuum condition within the welded pack.

In this regard, the bar stock 10 and 12 may also be formed preferably of 304 stainless steel. In the evacuated condition of the vacuum, the sheets 6 and 8 tightly engage the core plate 4 to ensure that no voids are present at the interface so as to increase the thermal conductivity through the cross section of the griddle plate construction. After the griddle plate 2 of FIGS. 1-3 has been constructed in this manner, various elements such as brackets or a grease trap can be welded to the griddle plate without destroying the vacuum condition within the interior. The weld is preferably a tungsten inert gas or a TIG weld, or it may be an automated laser weld. The thinner the sheets 6 and 8, the more the composite acts like the core, and no thermal warpage is present as the griddle plate is heated due to the differences in thermal expansion properties between the core plate 4 and the sheets 6 and 8. The carbon foam material of the core plate 4 has a very low coefficient of thermal expansion which provides a very flat cook surface when the griddle plate 2 is heated.

A further variation of the griddle plate shown in FIGS. 1-3 can be better appreciated with reference to FIG. 3 wherein two spaced-apart core plates 4 and 4′ are utilized having a space 16 therebetween. In such a construction, the griddle can be divided into two independent heating zones maintained at two different temperatures by virtue of the insulating air gap provide by space 16 between the adjacent core plates 4 and 4′. In this manner, of course, a multitude of different heating zones can be achieved merely by utilizing separate core plates separated by spaces. For example, four separate heating zones could be achieved in the griddle plate 2 by utilizing four separate core plates 4 (not shown), each placed in one of the four quadrants of the griddle plate and separated by spaces 16 providing heat insulating air gaps therebetween.

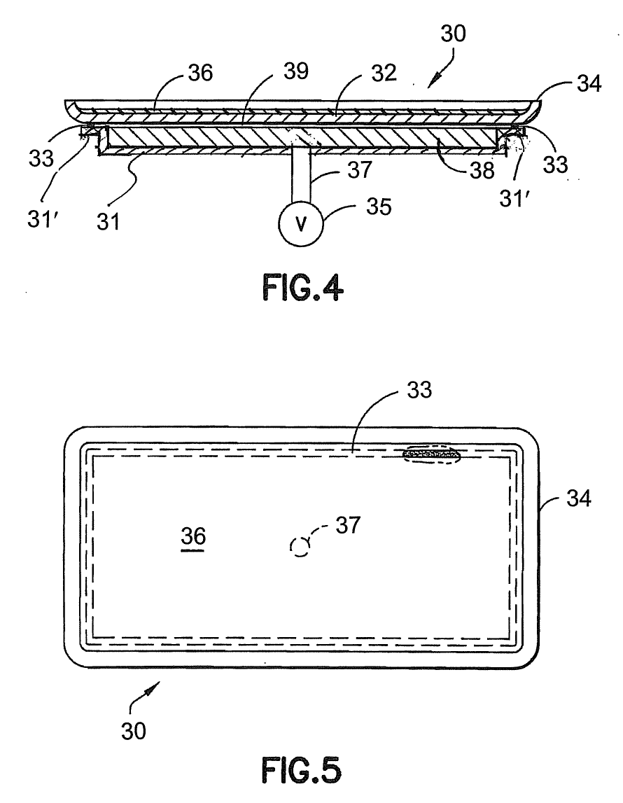

A further presently preferred embodiment of my invention is depicted in FIGS. 4 and 5 and identified generally as griddle plate 30. Griddle plate 30 comprises an upper metal sheet 32 having a gasket or bead of high temperature adhesive sealant 33 applied around its perimeter in contact with the peripheral flange 31′ of a lower metal sheet 31. A presently preferred high temperature, adhesive sealant 33 is a copper silicone “CU-371” sealant manufactured by INTEK Adhesives Ltd., U.K. The upper sheet 32 preferably is a drawn shape having an upwardly formed edge 34 with a non-stick cook surface 36 of Teflon®, for example, applied thereto. A vacuum pump 35 communicates with the space 39 between the upper sheet 32, core plate 38, and lower sheet 31 by way of a conduit 37 to maintain a constant vacuum in the space 39 to ensure intimate contact between the sheet 32 and the high heat conductive plate 38 of copper or aluminum. The sheets 32 and 33 are preferably stainless steel. It is contemplated that the griddle plate 30 would be sold as a unit with the vacuum pump 35 integral therewith. The pump 35 would be activated when the griddle is in use so as to maintain an intimate contact between the cook surface sheet 32 and the high heat conductive core plate 38. In the event the non-stick surface 36 becomes worn, the entire plate 32 can be replaced merely by shutting off the vacuum pump 35 and removing the sheet 32 from the flange 31′ of the lower formed sheet 31. A new, replacement upper sheet 32 with a fresh non-stick surface 36 applied thereto may then be reapplied over the high heat conductive core plate 38 and lower sheet 31 and the vacuum reestablished by activation of the vacuum pump 35. A fresh gasket or bead of adhesive sealant 33 would also be applied as previously described in order to establish a vacuum-tight seal between the new upper sheet 32, the core plate 38, and lower sheet 31.

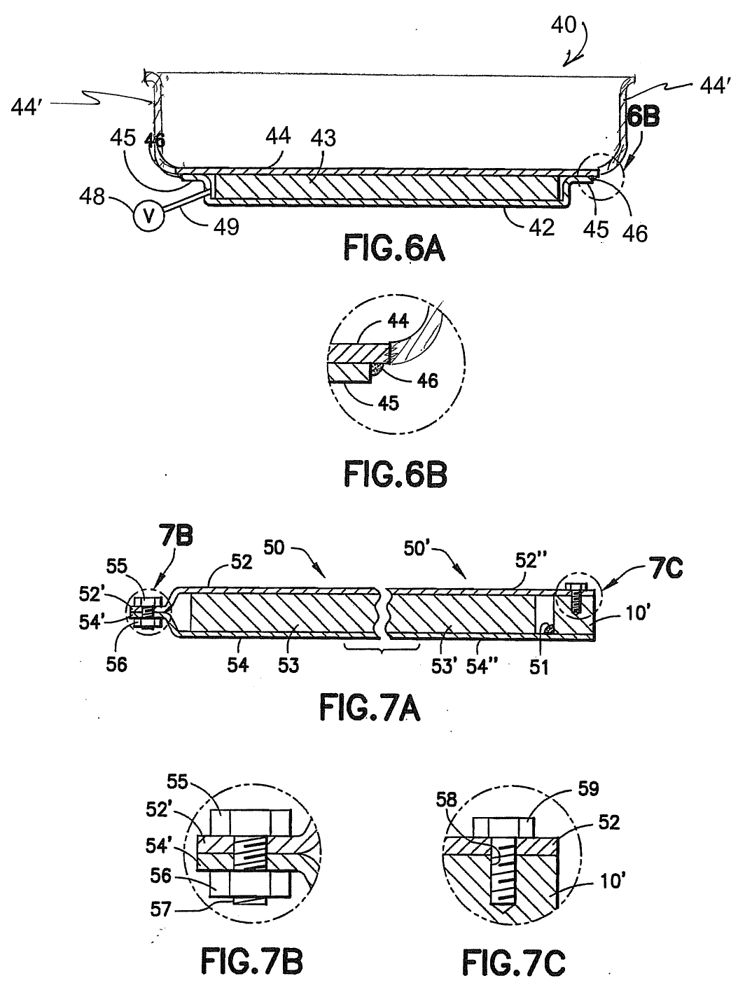

A still further embodiment of the present invention suitable for cookware is depicted in FIGS. 6A and 6B designated by reference numeral 40. The cookware 40 comprises a draw formed lower sheet 42 of aluminum, stainless steel, or a composite of both, and a deep drawn upper sheet 44 having an upwardly formed sidewall 44′, also of aluminum, stainless steel, or a composite. The upper sheet 44 defines the cook surface of the cookware. A core plate 43 of carbon foam is, likewise, provided. The lower sheet 42 carries an upturned peripheral flange 45 which conveniently supports the top sheet 44. A continuous weld bead 46, as more clearly seen in FIG. 6B, establishes an airtight seal within the interior space between the upper and lower sheets where the core plate 43 resides. A vacuum pump 48 communicates with a conduit 49 for establishment of a vacuum within the interior. Once again, a vacuum, preferably greater than about 25 to 30 inches of mercury within the interior, is preferred to establish intimate contact between the metal sheets 42, 44 and core plate 43. When a vacuum of the desired magnitude has been established, the conduit 49 is sealed off and the cookware 40 is ready for use. Of course, one or more handles (not shown) would be attached to the sidewall 44′ of the cookware. In the case where the metal sheets 42 and 44 are made from aluminum, the inner cook surface of the sheet 44 can have a non-stick surface such as PTFE applied thereto and the outer surfaces of side walls 44′ and lower sheet 42 may be anodized.

A still further embodiment of the present invention with a replaceable cook surface is depicted in FIGS. 7A-7B by reference numeral 50 and 50′. The griddle plate 50 shown in the left-hand portion of drawing FIGS. 7A and 7B comprises an upper sheet 52 and a lower sheet 54 of stainless steel or other metal carrying, respectively, flanges 52′ and 54′. The upper and lower sheets 52 and 54 closely engage a core plate 53 of carbon foam. A peripheral seal is mechanically established by way of a plurality of bolts 55 and nuts 56 which threadably engage the threaded bolt shaft 57, FIG. 7B. A gasket or adhesive sealant (not shown) may also be applied within the interface between the flanges 52′ and 54′ to ensure that a vacuum condition is established as previously described.

A further embodiment of the griddle plate 50′ is shown on the right-hand portion of FIG. 7A wherein the lower sheet 54″ is joined at weld bead 51 around the perimeter of the griddle plate to peripheral bars 10′. The top sheet 52″ is bolted to the bar 10′ by way of a plurality of bolt-like fasteners 59 threadably secured within threaded bores 58 formed in the bar 10′. Likewise, an airtight gasket or high temperature sealant may be applied (not shown) between the upper plate 52″ and the peripheral bars 10′. While not shown specifically in FIG. 7A, of course, it would be understood that an external vacuum would be applied to the interior of the griddle plate to establish a vacuum of at least 27 inches of mercury and then sealed off prior to use as previously described with the embodiments discussed above.

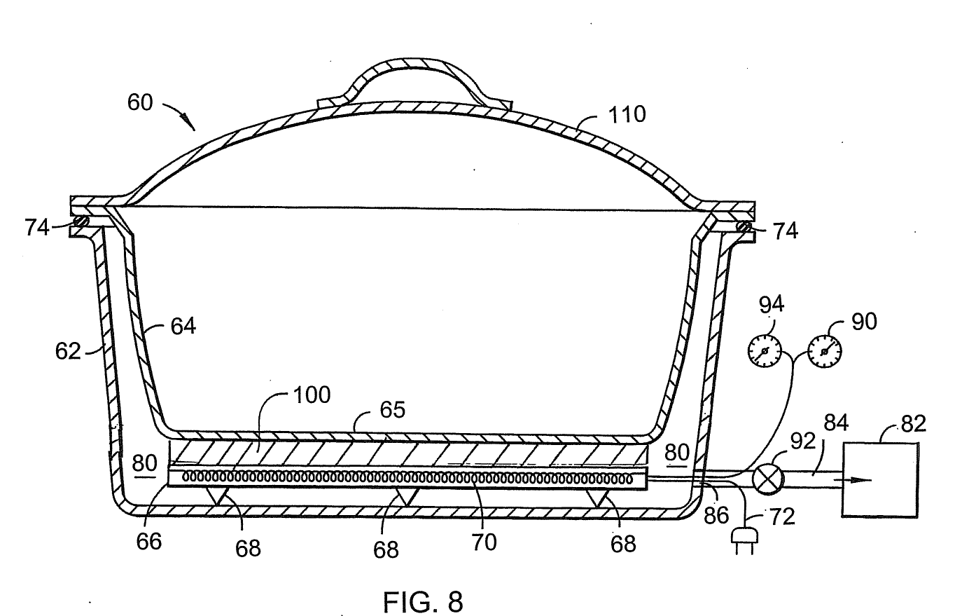

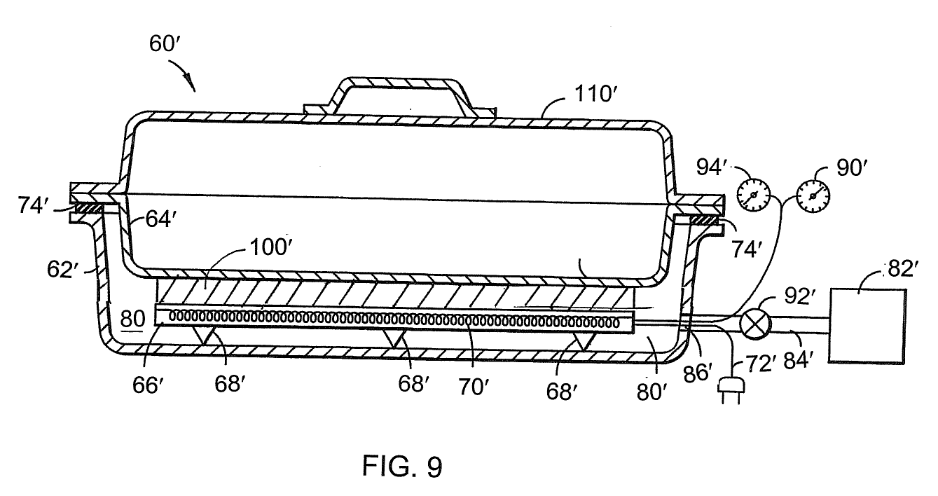

Food preparation with an electrical cooking device as pointed out in my co-pending application Ser. No. 11/439,507 represents certain advantages such as portability and versatility, and certain drawbacks such as lack of ease of cleaning, evenness of heating, and safety. The present invention further provides an electrical cooking apparatus with unique features in construction and performance that addresses the shortcomings of the traditional electrical cooking apparatus. The central feature of this appliance is the use of vacuum as both an insulator and as a means of attaching the cooking vessel to the heat source. FIGS. 8 and 9 schematically depict several generic arrangements of the apparatus of the present invention using the carbon foam material as a heat conductive plate 100.

The vacuum cooking appliance 60 shown in FIG. 8 is suitable for use as a food cooking or warming apparatus and particularly as a slow cooker, corn popper or similar device. The appliance 60 includes an outer shell 62, an inner food contacting vessel 64, and a heat sink plate 66 supported within the shell 62 by support legs 68. A resistance heater 70 is associated with the heat sink plate 66 having an external power cord and plug 72 associated therewith to supply electrical energy thereto. A carbon foam heat conductive plate 100 is placed on the top surface of the heat sink plate 66. A ring-shaped gasket 74 positioned between outwardly flared flanged rims of the shell 62 and food vessel 64 provides a vacuum tight seal between the shell and vessel when the interior space 80 between shell 62 and food vessel 64 is evacuated by a vacuum pump 82. The vacuum pump 82 communicates with the interior space 80 by way of a conduit 84 and passage 86 formed through the wall of the shell 62. Controls include a thermostat 90, solenoid 92 and vacuum switch 94. A lid 110 is also preferably included to cover the food vessel 64 when in use and also during preheat.

A vacuum is created in the interior space 80 defined between the outer shell 62 and the food vessel 64 by the vacuum pump 82. The high temperature seal 74 is somewhat compressible which allows the exterior bottom wall of the cook surface 65 of the food vessel 64 to come into intimate contact with the upper surface of the carbon foam plate 100 as vacuum builds within space 80 while the heat sink plate 66 forcibly engages the low surface of the carbon foam plate 100. The heat sink 66 is a thicker plate of metal (copper, aluminum, steel, etc.) which is intended to store latent energy from the resistance heater 70, delivers that energy to the carbon foam plate 100 which then conducts the heat in a rapid and even manner to the cook surface 65 of the food vessel 64. The mass of the heat sink plate 66 is adjusted to fit the application of the apparatus 60. The heat sink plate 66 is preferably one of aluminum or copper.

The temperature of the heat sink 66 is controlled by the thermostat 90 which has a probe connected directly to the heat sink or by means of a non-contact sensing device. The elements of the resistance heater 70 may be mechanically attached to the heat sink 66 or may be cast into the heat sink. The wattage of the resistance heaters is adjusted according to the application of the apparatus 60. The lid 110 is provided which securely fits the outer shell 62 as well as the food preparation vessel 64. During a pre-heat period, the lid 110 is placed on the high temperature gasket 74 without the food vessel placed in the outer shell. The vacuum pump 82 is turned on and the resulting vacuum that is developed in the interior space defined between the lid 110 and shell 62 insulates the heat sink plate 66 during the heat-up period. To start the cooking cycle, the solenoid 92 opens and vents the evacuated space between the outer shell 62 and lid 110 so that the lid may be removed and the food vessel 64 put in place inside the shell 62. The vacuum switch 94 turns on the vacuum pump 82 and the thermostat 90 turns on the resistance heaters 70 as energy flows to the food vessel. The legs 68 which support the heat sink 66 provide a spaced gap between the bottom of the heat sink 66 and the outer shell 62. The height of the legs is adjusted to place the heat sink 66 in contact with the surface 65 of the vessel 64 so as to provide maximum clamping force between the food vessel 64 and heat sink 66 when the vacuum is applied. This great clamping force is possible by virtue of the fact that the space 80 is under vacuum while the space above the food vessel is at atmosphere. The resultant net force acting to press the surface 65 against the carbon foam plate 100 and heat sink 66 may be well in excess of 1,000 pounds. The lid 110 which was used to maintain the vacuum during the pre-heat period fits the food vessel 64 and can be used as a lid during the cooking cycle.

The food vessel 64 can be made from a food grade material such as stainless steel or a less expensive material such as aluminum which is coated with a synthetic material such as a PTFE (non-stick). A multi-ply bonded material of stainless steel-aluminum-stainless steel, for example, would also be useful as a material for the food vessel 64 to promote heat flow to the food vessel and to conduct heat throughout the vessel.

The wires to the resistance heater 70 and the thermostat 90 must pass through the outer shell 62, such as through port 86, without allowing loss of vacuum. This is accomplished through the use of appropriate gaskets and sealants. The vacuum port 86 to the outer shell can also double as the entry point for these wires to minimize the number of possible vacuum leakage points in the outer shell 62. Energy consumption is minimized by the design of the apparatus as outlined below.

A. Convection loss is minimized by the evacuation of the space 80 surrounding the heat sink 66 during the heat-up period. Convection loss is minimized during the cooking cycle by reestablishing the vacuum after the lid has been removed and the food vessel 64 has been put in place in a sealed relationship at gasket 74 with the outer shell 62.

B. Conduction losses are minimized by using a low conductivity material for the heat sink support legs 68 such as stainless steel or ceramics to space the heat sink plate 66 from the shell 62. Also, the contact points for the legs 68 are kept to a minimum. Hence, loss of heat by conduction from the heat sink plate 66 to the shell 62 is minimized.

C. Radiant losses are minimized by providing a smooth reflective surface for the heat sink 66, the interior and the exterior of the outer shell 62.

With the food vessel 64 removed from the outer shell 62, the lid 110 is placed on the vacuum seal 74 that is located at the top flange of the outer shell 62. The apparatus 60 is turned on and the lid 110 is drawn down by the differential between the atmospheric pressure outside the lid and the vacuum beneath the lid, and the heat sink 66 begins to heat by virtue of the resistance heater 70. When the apparatus has achieved the pre-set vacuum level (approximately 23 inches of mercury) and the desired pre-set temperature, both the vacuum pump 82 and resistance heater 70 turn off. When desired, the operator switches the solenoid valve 92 which vents the evacuated space between the food vessel and the outer shell to atmosphere to free the lid. The lid is removed from the outer shell and the food vessel 64 with the food to be cooked thereon is placed inside the outer shell 62 with the upper flange of the food vessel 64 resting on the high temperature seal 74. Vacuum is reestablished and a tight clamping force is generated between the cook surface 65 of the food vessel 64 and the carbon foam plate 100 and the heat sink 66. When the cooking cycle is finished, the food vessel 64 is removed and the unit is either turned off or the lid is replaced on the vacuum seal to maintain the heat in the heat sink 66.

The apparatus depicted in FIG. 9 has generally the same structural elements as the apparatus shown and described in FIG. 8. Accordingly, like elements will be designated with the same numerals, but with prime symbols added in FIG. 9.

As shown in FIG. 9, an apparatus 60′ of the same generic construction as apparatus 60, but with an outer shell 62′ of rectangular shape, for example, measuring 12 inches by 16 inches, is fitted with a strong, well-insulated lid 110′ that will withstand the atmospheric pressure without collapsing under vacuum during the preheat period. The plane of the carbon foam plate 100 is only ⅛″ below the plane of the top of the vacuum seal 74′ in its uncompressed state. The apparatus reaches preset heat and vacuum levels and idles. When desired, the vacuum is broken and the lid 110′ is removed and replaced with a formed thin sheet of stainless steel or titanium which acts as a food vessel 64′ in the form of a griddle cooktop 65′. Atmospheric pressure secures the stainless sheet defining food vessel 64′ in place at the seal 74′ and on the carbon foam plate 100′ and, in turn, the heat sink plate 66′. The latent energy from the heat sink 66′ allows meat, such as hamburger patties, to be cooked rapidly and evenly across the griddle plate cooktop 65′. By way of example, the heat sink plate 66′ may be an aluminum plate about 0.75 inches thick and the food vessel 64′ may be a sheet of 304 stainless steel having a thickness of about 0.017 inches. The preheat lid 110′ fits over the formed stainless sheet 64′ to promote cooking, minimize heat loss and prevent splatter. Since the griddle cooktop 65′ is in intimate contact with the carbon foam plate 100′ and heat sink plate 66′ by virtue of the vacuum condition within the interior 80′, the cooktop 65′ will remain at a constant temperature over its entire surface and will also experience almost instantaneous thermal recovery when cold or frozen food is placed on the surface of cooktop 65′. This is particularly advantageous in commercial griddles where frozen hamburger patties are cooked. Thus, the invention ensures uniform and safe cooking in a commercial food preparation environment.

Two outer shells (not shown, but similar in concept to shell 62) are attached by a hinge in a “clam shell” type of arrangement. Both halves are equipped with a carbon foam plate 100, heat sink 66 and a port 86 to a vacuum pump 82. When the two halves are closed on each other, high temperature seals 74 around the perimeter of each shell contact the other. In other words, the clam shell is closed and the vacuum seal of each half contacts the other half. Vacuum is established and the heat sinks 66 in each half are preheated to a desired temperature. When desired, the vacuum is vented to atmosphere and the clam shell is opened. Grill vessel plates 64 which may include cast aluminum with a non-stick coating are placed against the vacuum seals 74 and vacuum is established in each of the two halves. When the clam shell is closed again, it may be used as a waffle maker, a two-sided grill, a panini press, or any other two-sided heat source application. The usage is determined by the plates or sheets 64 which are vacuum attached to the heat sinks 66 within the outer shells 62.

A further application is similar to FIG. 8, however, the outer shell 62, food preparation vessel 64 and lid 110 may be shaped in a rectangular configuration (in plan view) to assume the general size and configuration of a commercial warming tray or chafing dish. In such commercial settings, it is important to maintain the already cooked food at a holding/serving temperature between about 167° F.-185° F. This temperature range is of importance because bacteria will grow at temperatures below 167° F. and cooking will continue at temperatures above 185° F. The operation of the food warming device of this embodiment is the same as that set forth in the previous embodiments except that the temperature of the heat sink plate is maintained between 167° F.-185° F. so that precooked food placed in the food vessel 64 remains at a safe temperature during holding/serving without being overcooked.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

1. A composite griddle plate comprising a first sheet of metal defining a cook surface and a core plate of a carbon foam material having a relatively high coefficient of heat conductivity and low density wherein the said first sheet remains in intimate contact with an upper surface of the core plate with the aid of a vacuum.

2. The griddle plate of claim 1 wherein the first sheet is one of stainless steel or titanium.

3. The griddle plate of claim 1, including a second sheet of metal defining a lower surface which is also in intimate contact with a lower surface of the core plate with the aid of said vacuum.

4. The griddle plate of claim 1, wherein the composite griddle plate is sealed around a perimeter thereof.

5. The griddle plate of claim 4, wherein the griddle plate is under a permanent vacuum.

6. The griddle plate of claim 4, wherein the griddle plate is under a continuous vacuum applied by a vacuum pump during use.

7. The griddle plate of claim 4, wherein the seal is provided by welding.

8. The griddle plate of claim 4, wherein the seal is provided by gasket means.

9. The griddle plate of claim 6, wherein the first metal sheet defining the cook surface has a non-stick surface applied thereto and wherein said first metal sheet is detachable from said composite to permit replacement of said first metal sheet.

10. The griddle plate of claim 9, wherein the upper sheet is stainless steel and the non-stick surface is a fluorocarbon.

11. Cookware comprising:
(a) a first metal sheet;
(b) a second metal sheet; and
(c) a core plate disposed between the first and second metal sheets sealed in a vacuum-tight environment, wherein the core plate is a carbon foam material.

12. The cookware of claim 11 in the form of a fry pan.

13. The cookware of claim 11 in the form of a griddle plate.

14. The cookware of claim 11 wherein the first and second metal sheets are aluminum.

15. The cookware of claim 14 wherein the first sheet of aluminum has a non-stick surface applied thereto to define a cooking surface.

16. The cookware of claim 15 wherein the second sheet of aluminum has an anodized surface applied thereto to define an exterior surface of the cookware.

17. The cookware of claim 16 in the form of a fry pan.

18. The cookware of claim 11 wherein the first and second metal sheets are stainless steel.

19. The cookware of claim 11 wherein the first and second metal sheets are multi-ply composite sheets containing aluminum and stainless steel layers.

20. A cooking or warming appliance comprising:
(a) an outer shell;
(b) a heat sink plate positioned within the shell;
(c) heating means for heating the heat sink plate within the shell;
(d) a carbon foam plate placed on a top surface of the heat sink plate;
(e) a food vessel for placement within the outer shell, said vessel having a lower surface adapted to engage the carbon foam plate; and
(f) vacuum means associated with the shell to create a vacuum around the heat sink plate and carbon foam plate whereby the lower surface of the food vessel and the top surface of the heat sink plate tightly engage opposed planar surfaces of the carbon foam plate upon application of the vacuum.

21. The appliance of claim 20 including sealing means co-acting between the food vessel and the outer shell to maintain the vacuum between the shell and the food vessel.

22. The appliance of claim 20 wherein the heating means comprises a resistance heater associated with the heat sink plate.

23. The appliance of claim 20 wherein the heat sink plate is spaced from the outer shell by support means to minimize conduction heat loss from the heat sink plate to the outer shell.

24. The appliance of claim 23 wherein the support means is one or more support legs.

25. The appliance of claim 23 wherein interior surfaces of the outer shell and heat sink are treated to reduce radiant heat losses.

26. The appliance of claim 21 including a lid to selectively cooperate with the sealing means when the food vessel is removed from the outer shell to provide a sealed interior within the outer shell for creation of a vacuum during one of preheat or idle at temperature.

27. The appliance of claim 26 wherein the lid is adapted to fit on said food vessel.

28. A food cooking or warming appliance comprising:
a. an outer shell;
b. a heat sink plate positioned within the interior of the shell;
c. resistance heating and control means associated with the heat sink plate for heating the plate to a desired temperature;
d. a carbon foam plate placed on a top surface of the heat sink plate;
e. a food vessel for selective placement within the outer shell, said vessel having a food contacting surface for placement adjacent to said heat sink plate;
f. a lid adapted to selective engagement with one of the outer shell or the food vessel;
g. a vacuum pump means communicating with the interior of the outer shell; and
h. a sealing means cooperating between the lid and the outer shell and between the food vessel and the outer shell.

29. The appliance of claim 28 in the form of a popcorn maker.

30. The appliance of claim 28 in the form of a slow cooker.

31. The appliance of claim 28 in the form of a food warming chafing dish.

32. The appliance of claim 28 in the form of a fry pan or grill.

33. A method of cooking or warming food comprising the steps of:
a. providing an outer shell;
b. providing heating means within the outer shell;
c. providing a carbon foam plate positioned on a top surface of the heating means;
d. providing vacuum means for selectively providing a vacuum around the carbon foam plate and the heating means;
e. providing a food vessel for placement in the outer shell whereby the food vessel is adapted to contact the carbon foam plate;
f. providing lid means adapted to fit the outer shell and the food vessel; and
g. providing sealing means to establish a vacuum tight seal between the lid and the outer shell during a preheating step and between the food vessel and the outer shell during a cooking or warming step.

34. The method of claim 33 wherein the preheating step comprises the steps of:
a. placing the lid on the outer shell to engage said sealing means;
b. energizing the vacuum means to create a vacuum environment within an interior space defined by said outer shell and said lid; and
c. energizing the heating means within the vacuum environment to obtain a desired preheat temperature and maintaining said temperature.

35. The method of claim 34 wherein the cooking or warming step comprises the steps of:
a. de-energizing the vacuum means and removing the lid from the outer shell;
b. placing the food vessel in the outer shell to engage said sealing means;
c. re-energizing the vacuum means to recreate a vacuum environment within an interior space defined by said outer shell and said food vessel, said vacuum environment causing forcible engagement between the food vessel and the heating means on opposed sides of the carbon foam plate, as well as insulating said heating means from convection heat losses.

36. The cookware of claim 11 wherein the first metal sheet is a roll bonded multi-ply composite containing aluminum and stainless steel layers and the second metal sheet is stainless steel.

37. The cookware of claim 36 in the form of a fry pan.

38. The cookware of claim 36 wherein the second metal sheet of aluminum has an anodized surface applied thereto to define an exterior surface of the cookware.

39. The cookware of claim 36 wherein the first metal sheet has a non-stick surface applied thereto to define a cooking surface.
